(19) United States
(12) Patent Application Publication
(10) Pub. No.: US 2006/0004723 A1
(43) Pub. Date: Jan. 5, 2006

(54) Device, method, and computer product for reading tag data included in compressed data file

(75) Inventors: Akihito Fujiwara, Yamagata (JP); Seiji Nakano, Yamagata (JP); Masakazu Takahashi, Yamagata (JP); Hiroyuki Akama, Yamagata (JP); Kazunori Saitoh, Yamagata (JP); Kazushige Kawana, Saitama (JP); Akihiro Hashimoto, Saitama (JP)

Correspondence Address: FOLEY AND LARDNER LLP;SUITE 500, 3000 K STREET NW, WASHINGTON, DC, 20007, US

(73) Assignees: PIONEER CORPORATION; TOHOKU PIONEER CORPORATION; PIONEER SYSTEM TECHNOLOGIES CORPORATION

(21) Appl. No.: 11/138,315

(22) Filed: May 27, 2005

(30) Foreign Application Priority Data
May 31, 2004 (JP) 2004-160620

(51) Int. Cl. G06F 17/30

(52) U.S. Cl. 707/3

(57) ABSTRACT

A method for reading tag data is provided, involving reading a compressed data file that includes compressed data and tag data of a fixed length appended to the compressed data at a predetermined position, and performing a predetermined process based on the type of the compressed data. The reading process of the compressed data file includes first searching for the starting position of the tag data of the compressed data file and retrieving the tag data, followed by searching for the starting position of the compressed data.

### BACKGROUND OF THE INVENTION

1) Field of the Invention

The present invention relates to technology for reading tag data included in a compressed data file.

2) Description of the Related Art

Advancement in data compression technology in recent years has made it possible to compress audio data such as songs, music, etc. and video data such as movies and be used as digital data. The compressed digital data is recorded on an optical recording medium such as a compact disk (CD), a digital versatile disk or digital video disk (DVD), or a magneto optical recording medium such as a mini disk (MD), or a magnetic recording medium such as a hard disk. The digital data is decoded and played in a predetermined format by a suitable player.

For instance, MP3 (MPEG1 Audio Layer 3) is a widespread audio data compression technology that allows compression of audio data such as songs, music, etc. without degrading the sound quality. The music data compressed by means of the MP3 method is stored on a CD in the form of an MP3 file and is played by an MP3 file player. However, when the number of MP3 files on a CD becomes considerable, it is difficult to recognize the contents of the MP3 files merely by their titles. Therefore, an area called ID3Tag is secured in the MP3 file for storing text data pertaining to the MP3 file such as the title of the music data, artist name, etc. The format of the ID3Tag that is compatible with most of the MP3 file players is called ID3Tag Ver1. A fixed length data area of 128 bytes, containing data such as the title, artist name, etc. of the MP3 file, is appended to the end of the MP3 file. FIG. 1 is a schematic diagram of an MP3 file structure in which the ID3Tag Ver1 is appended to the music data. As shown in FIG. 1, an MP3 file 1 includes music data 2 in the form of compressed song or music data and an ID3Tag Ver1 (hereinafter, “ID3Tag”) 3 appendedappended to the end of the music data 2 and that stores information pertaining to the music data 2. A recording medium usually stores a series of MP3 files 1a, 1b, 1c, and so on, of the aforementioned format.

A process of how an MP3 file player reads the ID3Tag is explained next. FIG. 2 is a flowchart of a conventional method by which the MP3 file player reads the ID3Tag. FIG. 3 is a schematic for explaining the conventional method. When a user selects an MP3 file, the MP3 file player searches for the address of the specified MP3 file on the recording medium (step S11). That is, the MP3 file player retrieves from header data of the MP3 file, the data required for playing the music data, such as bit rate, sampling, etc. Based on the data volume of the specified MP3 file, the MP3 file player calculates the address of the ID3Tag, and searches for the calculated address of the ID3Tag (step S12). The MP3 file player then reads the ID3Tag (step S13), retrieves the text data recorded in the data area, and displays it on a display unit of the MP3 file player (step S14). The MP3 file player then searches again for the starting position address of the MP3 file specified by the user (step S15), and starts playing the music data (step S16), thus ending the reading process of the ID3Tag.

Thus, the conventional MP3 file player automatically reads the ID3Tag before playing the MP3 file specified by the user. Even if the ID3Tag is blank, the conventional MP3 player without fail performs reading of the ID3Tag and only then plays the music data, resulting in unnecessary delay. The audio player disclosed in Japanese Patent Laid-Open Publication No. 2002-245720 is provided with a read specifying unit which allows the user to specify beforehand whether to read the ID3Tag prior to playing the MP3 file. If the user specifies that the ID3Tag is not be read, the audio player directly plays the MP3 file without reading the ID3Tag, and if the user specifies that the ID3Tag is to be read, the audio player plays the MP3 file after reading the ID3Tag. Thus, when the user specifies that the ID3Tag is not be read, the loading of the MP3 file can be started early; however, the ID3Tag data will not be displayed on the audio player. If the user specifies that the ID3Tag is to be read, the process until the time the MP3 file is played gets very complex, as shown in FIG. 2 and FIG. 3. For instance, as shown in FIG. 3, if the user selects the MP3 file 1b while the MP3 file 1a is playing or after the MP3 file has finished playing, the audio player will need to perform a total of three searches, namely, for the starting position of the MP3 file 1b (music data 2b), the starting position of the ID3Tag 3b, and the starting position of the MP3 file 1b. Therefore, there is a delay between the time the MP3 file is specified and the time when the MP3 starts playing.

According to the technology disclosed in Japanese Patent Laid-Open Publication No. 2002-245720, specification can be made in the audio player not to read the ID3Tag to shorten the duration until the next file is played. However, even though the duration is reduced, the disadvantage is that the user will not be able to see the data of the ID3Tag.

### SUMMARY OF THE INVENTION

It is an object of the present invention to at least solve the problems in the conventional technology.

According to an aspect of the present invention, a method for reading tag data of a compressed data file that includes compressed data and a data tag appended to the compressed data at a predetermined position, and performing a predetermined process based on a type of compressed data, includes searching a starting position of the tag data in the compressed data file, retrieving the tag data, and then searching a starting position of the compressed data.

According to another aspect of the present invention, a device that reads tag data of a compressed data file that includes compressed data and a data tag appended to the compressed data at a predetermined position and performs a predetermined process based on a type of compressed data, includes a searching/retrieving unit that first searches a starting position of the tag data in the compressed data file, retrieves the tag data, and then searches a starting position of the compressed data.

According to still another aspect of the present invention, a computer-readable recording medium stores therein a computer program that causes a computer to implement the above method.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic diagram of an MP3 file structure in which ID3Tag Ver1 is appended to music data;

FIG. 2 is a flowchart of a conventional method for reading the ID3Tag by an MP3 file player;

FIG. 3 is a schematic diagram of the conventional method for reading the ID3Tag by the MP3 file player;

FIG. 4 is a flowchart of a reading process of tag data of compressed data file according to the present invention;

FIG. 5 is a block diagram of an example of an MP3 file player; and

FIG. 6 is a schematic diagram of a process of the reading method of the ID3Tag of the MP3 file.

### DETAILED DESCRIPTION

Exemplary embodiments of the present invention-are explained next with reference to the accompanying drawings. The present invention is not limited by these embodiments and modes of operation.

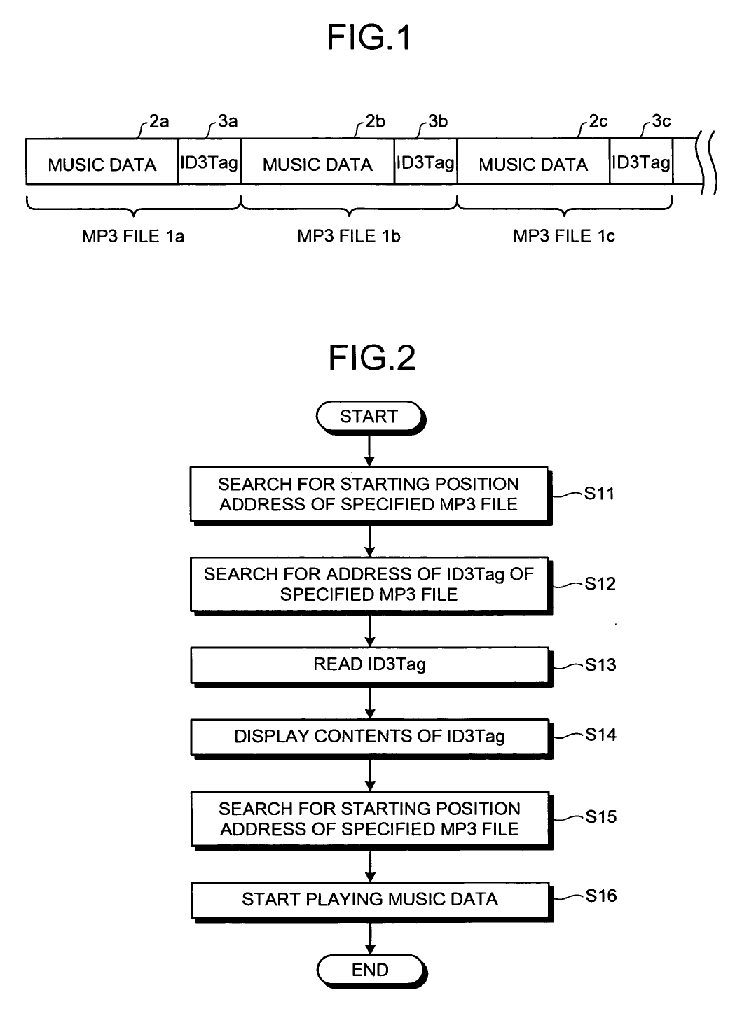

The method for reading tag data of a compressed data file according to the present invention can be applied to any compressed data file to which tag data of a fixed length containing information pertaining to the compressed data is appended at a predetermined position of the compressed data such as music data and video data containing compressed audio data and video data. For instance, the method can be applied to reading of tag data carried out by the compressed data player that reads compressed data file to which tag data of a fixed length is appended to the beginning of the compressed data or, as shown in FIG. 1, to the end of the compressed data, and carries out predetermined processes such as playing the compressed data file. The compressed data in the explanation that follows can assumedly be stored in any optical recording medium such as a CD, or DVD, or any magneto optical recording medium such as an MD or a magneto optical disk (MO), or any magnetic recording medium such as the hard disk.

FIG. 4 is a flowchart of the reading process of tag data of compressed data file according to the present invention. When switching from the currently playing compressed data file to another compressed data file, the compressed data player calculates the starting position address of the tag data of the compressed data file to be accessed and searches for the calculated address of the tag data (step S21). For example, if the tag data of a fixed length is appended to the beginning of the compressed data, the compressed data player searches for the starting portion address of the compressed data file to be accessed. If in the compressed data file the tag data of a fixed length is appended to the end of the compressed data, the compressed data player calculates the ending position address of the compressed data file by means of the starting position address and the size of the compressed data file to be accessed, deducts the size (fixed length) of the tag data from the ending position address to calculate the starting position address of the tag data, and searches for the calculated starting position address of the tag data.

The compressed data player reads the tag data from the found address (step S22), retrieves the text data recorded in the data area, and displays the text data of the compressed data player on the display unit (step S23). Following this, the compressed data player searches for the starting position address of the compressed data in the compressed data file to be accessed (step S24), and starts the reading process of the compressed data (step S25), thereby ending the reading process of the tag data of the compressed data file.

It is also possible to provide a computer program that causes a computer to read the tag data of a compressed data file appended to a predetermined position of the compressed data. The computer program can be provided either in installable form or executable form on a computer-readable recording medium such as a compact disk read only memory (CD-ROM), a floppy (Registered Trademark) disk, a DVD. Alternatively, the computer program can be stored on another computer connected to a network such as the Internet, and downloaded from the network. This enables the computer to load and execute the computer program.

According to the present embodiment, when switching from a currently playing compressed data file to another compressed data file, the compressed file player searches for the starting position address of the tag data of the other compressed data file, reads the tag data, and then searches for the starting position address of the compressed data, and performs the predetermined process. Consequently, when switching from one compressed data file to another, the duration up to the time when the processing of the other compressed data file begins is shortened.

A practical example will be explained below. In this practical example, an MP3 file shown in FIG. 1 is taken as an example of a compressed file. Precisely, the MP3 file includes music data compressed by means of MP3 method and a tag data ID3Tag Ver1 (hereinafter, “ID3Tag”) of a fixed length of 128 bytes appended to the end of the compressed music data. It is assumed that an MP3 file player is used for playing the compressed MP3 file.

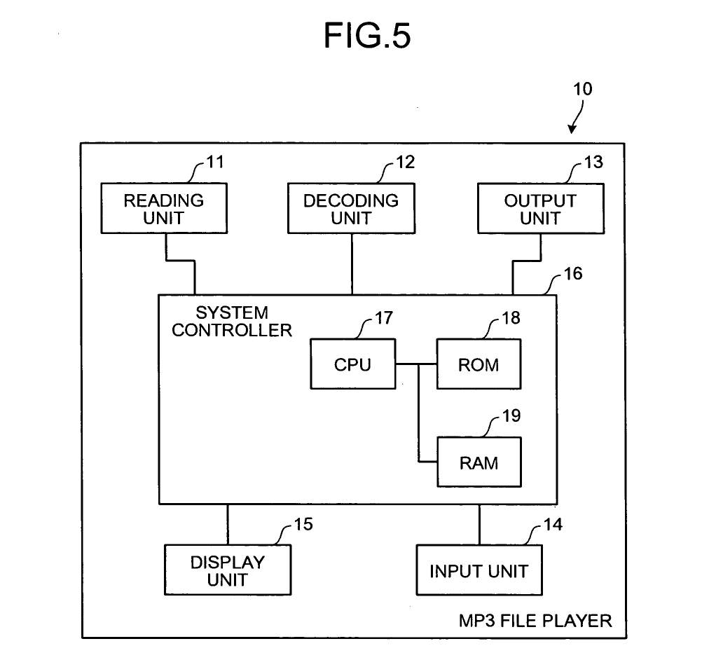

FIG. 5 is a block diagram of an example of an MP3 file player. An MP3 file player 10 includes a reading unit 11 that reads the MP3 files recorded on a recording medium such as a CD, DVD, MD, or hard disk, a decoding unit 12 that decodes the music data of the MP3 file read by the reading unit 11, an output unit 13 that outputs as a sound signal the decoded music data by either digital/analog conversion or amplification, a display unit 14 consisting of a display device such as liquid crystal display (LCD) that performs a predetermined display process, an input unit 15 consisting of either a keyboard, or various keys such as play, pause, cursor, etc. and that enables a user perform an input process, and a system controller 16 that controls the processes of the aforementioned parts. The system controller 16 consists of a central processing unit (CPU) 17, a read only memory (ROM) 18, and a random access memory (RAM) 19. Upon receiving from the user an input via the input unit 15, the CPU 17 reads from the ROM 18 the control programs or application programs required for the MP3 file player 10, stores these control programs and application programs in a program storage area in the RAM 19, and executes the various processes. The CPU 17 temporarily stores the various data that result from these processes in a data storage area in the RAM 19. In this way the CPU 17 controls the various processes of the MP3 file player 10. The system controller 16 executes an ID3Tag reading program to carry out the reading process of the ID3Tag of the MP3 file.

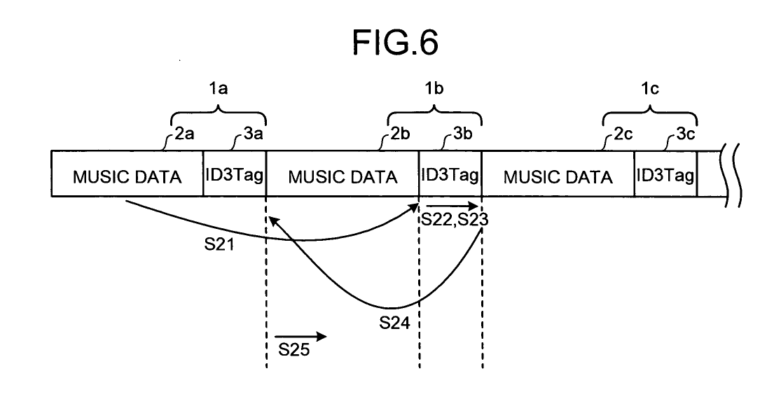

FIG. 6 is a schematic for explaining how the MP3 file player reads the ID3Tag of the MP3 file. The reference numerals in FIG. 6 correspond to the step numbers in the flowchart shown in FIG. 4. Assume, for instance, that the user inputs via the input unit 15 an instruction to play the MP3 file 1b while the MP3 file 1a is playing. The system controller 16 calculates the starting position of the IDTag3b of the MP3 file 1b from the starting point address and the size of the MP3 file 1b as well as the fixed length of the ID3Tag, and the reading unit 11 searches the starting position of the ID3Tag 3b of the MP3 file 1b (step S21). In other words, the system controller 16 determines the ending position address of the MP3 file 1b from the starting position address and the size of the specified MP3 file 1b, and the reading unit 11 determines the starting position address of the ID3Tag 3b by deducting the predetermined length (that is, 128 bytes) from the ending position address.

The reading unit 11 then carries out the reading process of the ID3Tag 3b (step S22), and the system controller 16 displays the read data on the display unit 14 (step S23). Once the reading process of the ID3Tag 3b is completed, the reading unit 11, searches for the starting position address of the MP3 file 1b (step S24) and starts the reading process of the music data 2b (step S25). When reading, the reading unit 11 first retrieves from the head data of the MP3 file, information such as bit rate, sampling rate, etc., required for playing the music data, followed by the music data 2b. The decoding unit 12 carries out a decoding process on the read music data. The output unit 13 carries out the playing process of the music data by outputting sound signals, thereby ending the ID3Tag reading process.

A case of the user inputting, by means of the input unit 15, the instruction to play the MP3 file 1b while the MP3 file 1a is playing has been presented as an example. However, the process of the MP3 file player 10 remains the same for playing the next MP3 file 1b after the current MP3 file 1a has finished playing.

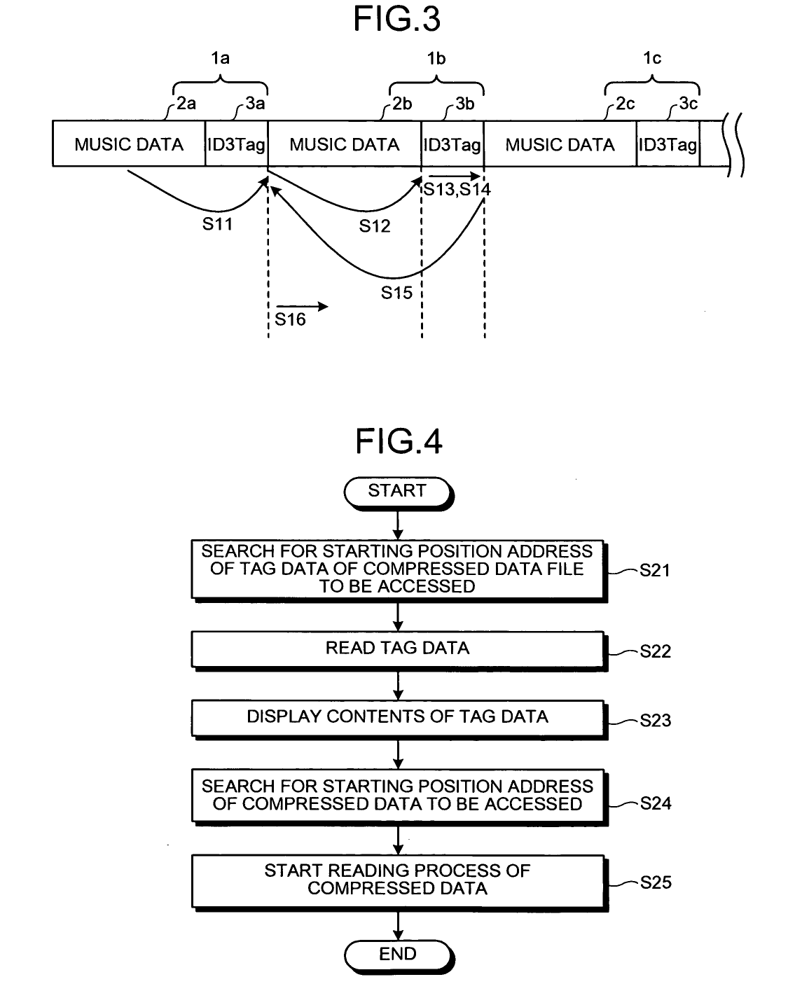

If the user instructs, by means of play instruction, to play another MP3 file, in the conventional method, the reading unit 11 first searches for the starting point address of the requested MP3 file 1, searches for and reads the starting point address of the ID3Tag 3, and once again searches for the starting point address of the MP3 file 1 to play the music data 2. On the contrary, in the present practical example, the reading unit 11 searches for the starting point of the ID3Tag 3 and follows it up with a search for the starting point of the MP3 file 1, then starts reading the data, thus playing the MP3 file 1. In other words, in the present practical example, as shown in FIG. 3, the need for the reading unit 11 to access the starting point of the next MP3 file 1 is obviated when changing the MP3 file, thereby reducing the duration between the stopping of the earlier MP3 file and the starting of the music data 2.

According to the present practical example, when there is an instruction for the currently playing MP3 file 1 to be changed, the starting point of the ID3Tag 3 of the MP3 file 1 to be played next is searched and read following which the starting point of the music data 2 of the MP3 file 1 is searched and played. Consequently, the duration between the stopping of the previous MP3 file 1 and starting of the next MP3 file 1 is reduced. Further, the display of the data stored in the ID3Tag 3 as well as the reduction of the duration up to the time the data is displayed is achieved without the user having to specify.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method for reading tag data of a compressed data file that includes compressed data and a data tag appended to the compressed data at a predetermined position, and performing a predetermined process based on a type of compressed data, comprising:
searching a starting position of the tag data in the compressed data file, retrieving the tag data, and then searching a starting position of the compressed data.

2. The method according to claim 1, wherein the searching includes searching the starting position based on an address of the starting position and a size of the compressed data file as well as a fixed length of the tag data.

3. The method according to claim 1, wherein if the tag data has a fixed length and is appended to the end of the compressed data, the searching includes searching the starting position by deducting the size of the tag data from an address of an ending position address of the compressed data file calculated based on the address of the starting position and the size of the compressed data file.

4. A computer-readable recording medium that stores therein a computer program that causes a computer to implement a method for reading tag data of a compressed data file that includes compressed data and a data tag appended to the compressed data at a predetermined position, and performing a predetermined process based on a type of compressed data, the computer program causing the computer to execute:
searching a starting position of the tag data in the compressed data file, retrieving the tag data, and then searching a starting position of the compressed data.

5. A device that reads tag data of a compressed data file that includes compressed data and a data tag appended to the compressed data at a predetermined position and performs a predetermined process based on a type of compressed data, comprising:
a searching/retrieving unit that first searches a starting position of the tag data in the compressed data file, retrieves the tag data, and then searches a starting position of the compressed data.

6. The device according to claim 5, wherein the searching/retrieving unit searches the starting position based on an address of the starting position and a size of the compressed data file as well as a fixed length of the tag data.

7. The device according to claim 5, wherein if the tag data has a fixed length and is appended to the end of the compressed data, the searching/retrieving unit searches the starting position by deducting the size of the tag data from an address of an ending position address of the compressed data file calculated based on the address of the starting position and the size of the compressed data file.
